(19) United States
(12) Patent Application Publication
(10) Pub. No.: US 2016/0277833 A1
(43) Pub. Date: Sep. 22, 2016

(54) Piezoelectric Speaker Driving Device

(71) Applicant: ZTE CORPORATION, Shenzhen City, Guangdong Province (CN)

(72) Inventors: Shijun QIN, Shenzhen (CN); Shimin YUAN, Shenzhen (CN); Xueheng BIAN, Shenzhen (CN)

(21) Appl. No.: 15/030,069

(22) PCT Filed: Apr. 24, 2014
(86) PCT No.: PCT/CN2014/076152

§ 371 Date: Apr. 18, 2016

(30) Foreign Application Priority Data
Sep. 18, 2013 (CN) 201320581345.1

(51) Int. Cl. H04R 3/04; H04R 3/00; H04R 17/00

(52) U.S. Cl. CPC H04R 3/04; H04R 17/005; H04R 3/007; H04R 2430/03; H04R 2430/01

(57) ABSTRACT

A piezoelectric speaker driving device includes a driving amplification unit, a signal tuning unit, and a piezoelectric speaker; wherein, the driving amplification unit is configured to amplify a signal source, and transmit an amplified signal to the signal tuning unit; the signal tuning unit is configured to filter the amplified signal to filter out a high-frequency noise, and regulate an impedance characteristic of the piezoelectric ceramic to increase a load impedance of a high-frequency part of the driving circuit so as to reduce the driving current of the high-frequency part, and transmit the regulated driving signal to the piezoelectric speaker to drive the piezoelectric speaker. Wherein, the signal tuning unit may include a low-pass filtering circuit and a regulation impedance.

### TECHNICAL FIELD

The present document relates to speaker technology, and in particular, to a piezoelectric speaker driving device in an electronic product such as a mobile phone, a tablet PC, etc including a speaker.

### BACKGROUND OF THE RELATED ART

When a piezoelectric crystal or piezoelectric ceramic is subjected to an external electric field, a mechanical deformation which is in linear relationship with the electric field intensity is generated in the piezoelectric crystal or piezoelectric ceramic. This phenomenon is known as inverse piezoelectric effect. Therefore, when an electric signal is applied on the electric ceramic, the electric ceramic itself may vibrate mechanically correspondingly, and further drive the ambient air to vibrate, so as to generate a sound.

In comparison to traditional moving-coil speakers, the piezoelectric speaker has advantages of compactness, lightweight, impact resistance, low electromagnetic radiation, and low power consumption, etc. However, because a critical piezoelectric ceramics of a piezoelectric speaker is a capacitive load, its impedance frequency characteristic is similar to that of a capacitor. FIG. 1 is a curve chart of impedance versus frequency of the related piezoelectric ceramic, the frequency is arranged along the abscissa (the unit is Hz), whereas the impedance is arranged along the ordinate (the unit is ohm). As shown by the curve in FIG. 1, when at a high frequency, the impedance is very low. As such, a piezoelectric speaker driving circuit is required to supply a higher current output, and a specially-designed driving circuit is needed to meet the requirement for stable driving.

In the application Serial Number “200880125607.5” entitled “A low-power piezoelectric amplifier and method thereof”, a problem of a current increasing at the high frequency part has been indicated, and a scheme for controlling a direction of a current flow of a circuit by a switch and a comparator is provided. However, with this method, when in use, not only the circuit and control design software is complicated, but also the self-oscillation of the circuit is easily brought due to parameter mismatching of the components, which will cause the piezoelectric element to produce high frequency howling.

In the application Serial Number “200810110462.3” entitled “ Power amplification circuit”, a power amplification circuit dedicated for piezoelectric driving is proposed, and two different sets of power amplification voltages are set to improve the output efficiency of the power amplifier effectively (one set of higher voltages therein is generated by a charge pump). However, in the circuit, a difference between a current increase caused by the reduced impedance at the high frequency part and a current increase caused by the increased input signal is not considered in the piezoelectric speaker, and an overlarge output current of the circuit is only suppressed by reducing the power amplification voltage similarly. Therefore, a distorted signal generated due to driving the circuit is brought, and quality of a reproduced sound is impaired enormously.

Furthermore, because the piezoelectric speaker has a stable deformation magnitude under a certain voltage, a sound pressure frequency response may be increased generally with the increased frequency. This phenomenon is inconsistent with the Hi-Fi reproducing requirement of the sound that the frequency response is required to keep smooth as far as possible. At present, reproduction systems of most piezoelectric speakers manifest high-pitched sounds because the high-frequency responses are much higher than the low-frequency responses.

In the application Serial Number “201020149309.4” entitled “Matrix form piezoelectricity panel speaker with a weighting structure and a damping structure”, a scheme for ameliorating an unevenness of the high frequency response of the piezoelectric speaker by increasing balance weight and damping structure in the piezoelectric speaker structure is disclosed. However, the method would increase the difficulty in product assembling, and the total thickness of the product will be increased.

### SUMMARY

To solve the above-mentioned technical problem, the present document provides a piezoelectric speaker driving device that simply improves the quality of the reproduced sound of the high-frequency part of the piezoelectric speaker without adjusting the structure and the assembly of the piezoelectric speaker, and the piezoelectric speaker driving device can ameliorate the problems of an increased driving power consumption and a self-oscillation of the circuit caused by the low impedance of the high-frequency part of the piezoelectric ceramic element.

The present document discloses the piezoelectric speaker driving device including a driving amplification unit for amplifying a signal source, and a piezoelectric speaker, the piezoelectric speaker driving device further includes a signal tuning unit, which is configured to filter a signal amplified by the driving amplification unit to filter out a high-frequency noise, regulate an impedance characteristic of a piezoelectric ceramic of the piezoelectric speaker, and transmit a regulated driving signal to the piezoelectric speaker to drive the piezoelectric speaker.

The signal tuning unit includes a low-pass filtering circuit and a regulation impedance.

The driving amplification unit includes a power amplifier and a power supply configured to supply the power for the power amplifier;

the low-pass filtering circuit is configured to be composed of an inductor cascaded in an output loop of the power amplifier and a capacitor connected in parallel in the output loop of the power amplifier, to filter out the high-frequency noise of an amplified signal from the power amplifier; and attenuate a high-frequency part of a sound pressure frequency responding curve of the piezoelectric speaker at a same time;

the regulation impedance is configured to be a resistor cascaded in the output loop of the power amplifier to regulate the impedance characteristic of the piezoelectric ceramic of the piezoelectric speaker.

An inductance of the inductor, a capacitance of the capacitor, and a resistance of the resistor are determined based on the frequencies corresponding to resonance peaks and resonance valleys of the high-frequency part of the piezoelectric speaker.

The inductor is a chip magnetic low-frequency inductor having an inductance in a range of 10 uH˜10 mH;

the capacitor is a chip ceramic capacitor having a capacitance in a range of 1 nF˜1 uF;

the resistor is a chip metal film resistor having a resistance in a range of 10˜100 ohm.

The inductance is 130 uH; the capacitance is 0.47 uF; and the resistance is 22 ohm.

The piezoelectric speaker driving device provided by the scheme of the present application includes the driving amplification unit, the signal tuning unit, and the piezoelectric speaker; wherein, the driving amplification unit is configured to amplify the signal source, and transmit the amplified signal to the signal tuning unit; the signal tuning unit is configured to filter the amplified signal to filter out the high-frequency noise; and regulate the impedance characteristic of the piezoelectric ceramic to increase the load impedance of the driving circuit at the high-frequency part, so as to reduce the driving current of the driving circuit at the high frequency part; and transmit the regulated driving signal to the piezoelectric speaker to drive the piezoelectric speaker. Wherein, the signal tuning unit includes a low-pass filtering circuit and a regulation impedance. The piezoelectric speaker driving device in accordance with the present document simply improves the quality of the reproduced sound of the high-frequency part of the piezoelectric speaker without changing the structure and the assembly of the piezoelectric speaker, and the piezoelectric speaker driving device ameliorates the problems of an increased driving power consumption and a self-oscillation of the circuit caused by the low impedance of the high-frequency part of the piezoelectric ceramic element.

### BRIEF DESCRIPTION OF DRAWINGS

FIG. 1 is a curve chart of impedance versus frequency of the related piezoelectric ceramic;

FIG. 2 is a schematic diagram of a composition structure of the piezoelectric speaker driving device in accordance with an embodiment of the present document;

FIG. 3 is a specific circuit diagram of the piezoelectric speaker driving device in accordance with an embodiment of the present document;

FIG. 4 is an equivalent circuit diagram of the related piezoelectric ceramic working in the vicinity of a resonance point;

FIG. 5 is a schematic diagram of the frequency response and THD of a related piezoelectric speaker driving circuit;

FIG. 6 is a schematic diagram of the frequency response and THD of the piezoelectric speaker driving circuit in accordance with an embodiment of the present document.

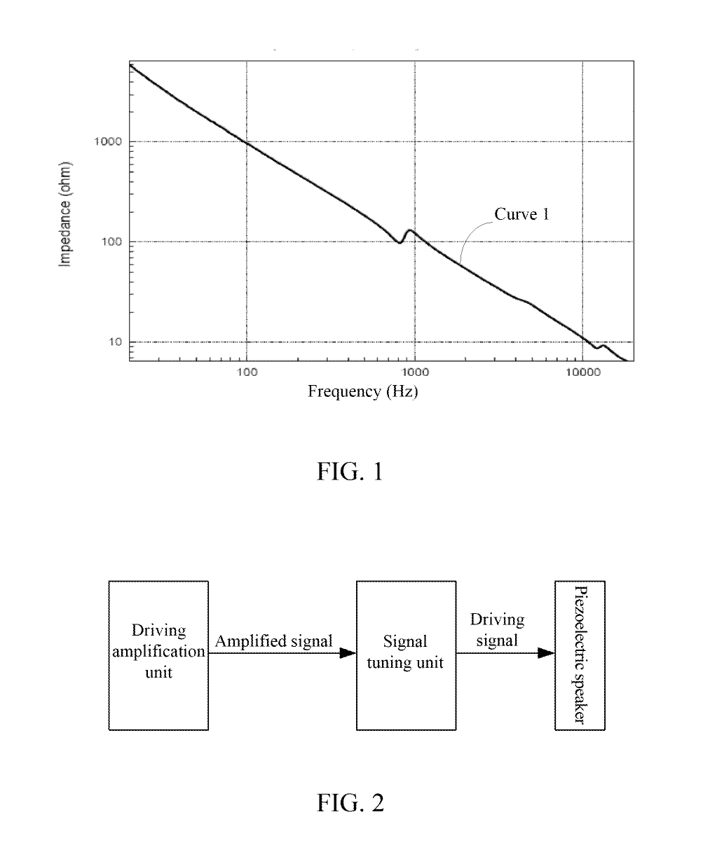

### PREFERRED EMBODIMENTS

FIG. 2 is the schematic diagram of the composition structure of the piezoelectric speaker driving device in accordance with an embodiment of the present document; the piezoelectric speaker driving device shown in the FIG. 2 includes the driving amplification unit, the signal tuning unit, and the piezoelectric speaker; thereinto,

the driving amplification unit is configured to amplify the signal source, and then transmit the amplified signal to the signal tuning unit; the specific implementation of the driving amplification unit belongs to the related art.

the signal tuning unit is configured to filter the amplified signal for filtering out a high-frequency noise, and regulate the impedance characteristic of the piezoelectric ceramic to increase the load impedance of the high-frequency part of the driving circuit and to reduce the driving current of the high-frequency part of the driving circuit, and transmit the regulated driving signal to the piezoelectric speaker to drive the piezoelectric speaker.

The signal tuning unit may include a low-pass filtering circuit and a regulation impedance.

The piezoelectric speaker driving device in accordance with the embodiment of the present document simply improves the quality of the reproduced sound of the high-frequency part of the piezoelectric speaker without changing the structure and assembly of the piezoelectric speaker, and the piezoelectric speaker driving device ameliorates the problems of the increased driving power consumption and the self-oscillation of the driving circuit caused by the low impedance of the high-frequency part of the piezoelectric ceramic element.

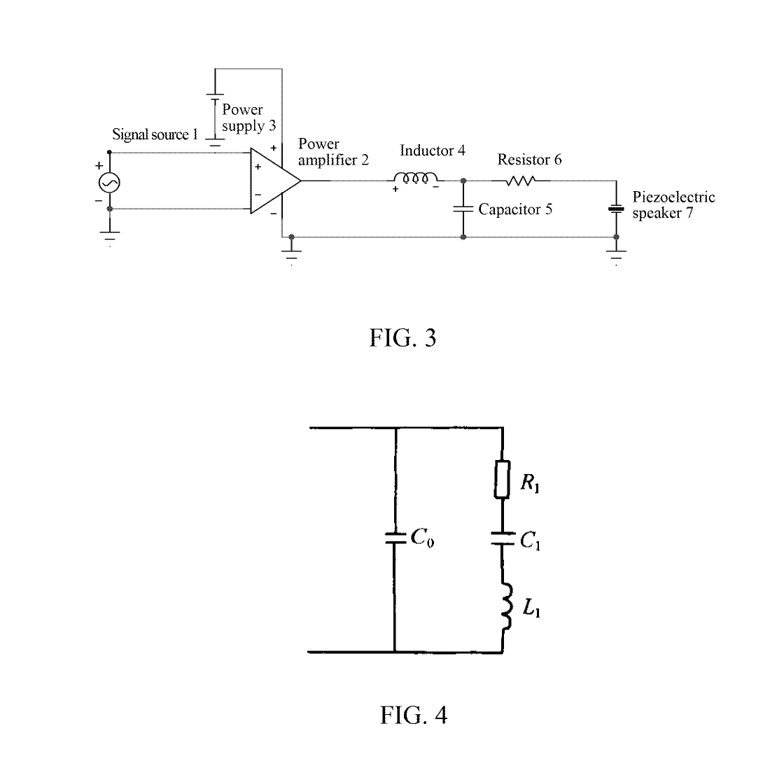

The specific embodiment has been described with reference to FIG. 3, and FIG. 3 is the specific circuit diagram of the piezoelectric speaker driving device in accordance with the embodiment of the present document, the driving amplification unit shown in FIG. 3 includes the power amplifier 2, a power supply 3; whereas the signal tuning unit includes an inductor 4, a capacitor 5, and a resistor 6; additionally, the piezoelectric speaker driving device further includes the piezoelectric speaker 7 and the signal source 1 required to be amplified.

Specifically, the signal source 1, i.e. an original electrical signal without amplification, may be voice (such as during a mobile phone call), or music (such as an MP3 song played in a tablet PC) according to different applications. Generally, the voltage of the signal source 1 is about 1 Vpp.

The power amplifier 2 is configured to amplify the original electrical signal from the signal source 1 to 10 Vpp˜20 Vpp, and then transmit the amplified signal to the signal tuning unit. For instance, the conventional power amplifier 2 may be a power amplifier with the No. TPA2100P1 commercially available from Texas Instruments, U.S.A.

The power supply 3 is configured to supply the power to the power amplifier. For instance, the power supply 3 of the mobile phone is a 3.7V Li-ion battery typically.

The low-pass filter is composed of the inductor 4 cascaded in an output loop of the power amplifier 2 and the capacitor 5 connected in parallel in the output loop of the power amplifier 2 to filter out the high-frequency noise of the amplified signal from the power amplifier 2, and attenuate a high-frequency part of a sound pressure frequency responding curve of the piezoelectric speaker at the same time to soften the voice.

The resistor 6 cascaded in the output loop of the power amplifier 2 is configured to regulate the impedance characteristic of the piezoelectric ceramic, and the load impedance of the high-frequency part of the driving circuit is increased by cascading the resistor 6, thus reducing the driving current of the high-frequency part effectively, reducing the system power consumption and improving the stability of the circuit.

The inductor 4 may be a chip magnetic low-frequency inductor having an inductance in the range of 10 uH˜10 mH; the capacitor 5 may be a chip ceramic capacitor having a capacitance in the range of 1 nF˜1 uF; and the resistor 6 may be a chip metal film resistor having a resistance in the range of 10˜100 ohm.

The piezoelectric speaker 7 is driven by the signal output by the signal tuning unit, to drive the air around to produce a sound by the vibration of the piezoelectric ceramic of the piezoelectric speaker.

It should be noted that, what is shown in FIG. 3 is only an embodiment, and not intended to limit the scope of the present document. A variety of particular implementations of the circuit will suggest themselves to those skilled in the art in view of the composition and structure of the piezoelectric speaker driving device shown in FIG. 2, what is stressed in the embodiment of the present document is that, a signal tuning unit is added to the output loop of the related driving circuit, and on one hand, the signal tuning unit is configured to filter the amplified signal to filter out a high-frequency noise, on the other hand, it is configured to regulate the impedance characteristic of the piezoelectric ceramic to increase the load impedance of the high-frequency part of the driving circuit so as to reduce the driving current, and transmit the regulated driving signal to the piezoelectric speaker to drive the piezoelectric speaker.

In the piezoelectric speaker driving device in accordance with the present document, a fluctuation of the high-frequency part of the piezoelectric speaker is corrected and attenuated by the low-pass filtering circuit of the signal tuning unit to improve the quality of the sound of the piezoelectric speaker; the load impedance of the high-frequency part of the driving circuit is increased by the regulation impedance of the signal tuning unit to reduce the power consumption of the piezoelectric speaker driving device and improve the stability of the circuit. The piezoelectric speaker driving device in accordance with the embodiment of the present document solves the drawback of the poor quality of the sound of the piezoelectric speaker applied in a portable electric device, and makes full use of advantages of thinness and low power consumption of the piezoelectric speaker.

In order to further improve the driving effect of the piezoelectric speaker driving device in accordance with the embodiment of the present document, the parameters of the inductor 4, the capacitor 5, and the resistor 6 are determined based on the frequencies corresponding to resonance peaks and resonance valleys of the high-frequency part of the piezoelectric speaker. The specific content is as follows:

The critical part of the piezoelectric speaker is the piezoelectric ceramic, as shown in FIG. 4, when working around a resonance point, it is equivalent to a circuit of a static capacitor C0 being connected in parallel with a branch of a capacitor C1, an inductor L1, and a resistor R1, wherein FIG. 4 is the equivalent circuit diagram of the related piezoelectric ceramic working around a resonance point.

A resonant frequency of a low-pass filtering circuit made up of the static capacitor C0, the capacitor 5, and the inductor 4 may be set according to the intermediate frequency between the peak and the valley of the high-frequency part of the piezoelectric speaker, i.e. a resonance impedance phase zero crossing, and fine tuning is performed on the capacitor 5 or inductor 4 to optimize.

The resistor 6 may be used to regulate the quality factor of a corresponding matching circuit, i.e. a Q value, with reference to the Q value at the valley of the frequency response of the high-frequency transition area of the piezoelectric speaker, so as to improve and optimize the valley of an output frequency response curve.

The specific implementation and effect of the present document will now be described in detail in connection with the embodiment in practice.

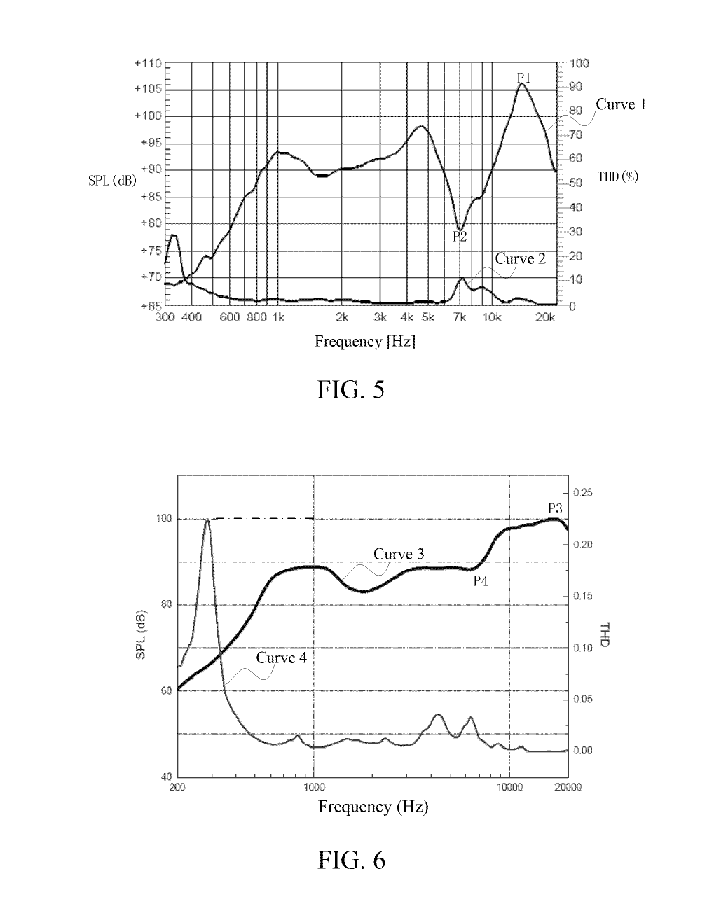

Taking a piezoelectric speaker no. PS2327, commercially available from KING TONE INNOVATION (BEIJING) CO., LTD, as an example, the power amplifier of the driving amplification unit may be a piezoelectric-dedicated driving circuit no. TPA2100P1 commercially available from Texas Instruments, U.S.A. In the piezoelectric speaker no. PS2327, the capacitance of the piezoelectric ceramic static capacitor CO may be in the range of 1.4±0.2 uF; the parameter of the capacitor 5 of the driving circuit may be chosen as 0.47 uF; the inductance of the inductor 4 may be chosen as 130 uH, and the resistance of the resistor 6 may be chosen as 22 ohm. The intermediate frequency between the peak and the valley of the high-frequency part of the piezoelectric speaker is about 10 kHz, and the intermediate frequency is in between the high-frequency peak (with reference to FIG. 5, is about 13 kHz) and the intermediate frequency valley, i.e. the frequency corresponding to the valley of the frequency response of the piezoelectric speaker (with reference to FIG. 6, about 7 kHz).

For the same piezoelectric speaker sample, FIG. 5 is a schematic diagram of the frequency response and the total harmonic distortion (THD) of a related piezoelectric speaker driving circuit, as shown in FIG. 5, the frequency is arranged along the abscissa (the unit is Hz), whereas the sound pressure level (SPL) is arranged along the left ordinate (the unit is dB), THD is arranged along the right ordinate (the unit is %); the curve 1 is the frequency response curve, the curve 2 is the THD curve, the sound pressure fluctuation of the high-frequency part of the piezoelectric speaker is about 25 dB (the peak P1 is about 105 dB, and the valley P2 is about 80 dB).

FIG. 6 is the schematic diagram of the frequency response and THD of the piezoelectric speaker driving circuit in accordance with an embodiment of the present document, as shown in FIG. 6, the frequency is arranged along the abscissa (the unit is Hz), whereas the SPL is arranged along the left ordinate (the unit is dB), THD is arranged along the right ordinate (the unit is %); the curve 3 is the frequency response curve, the curve 4 is the THD curve, it is evident from the drawings, the sound pressure fluctuation of the piezoelectric speaker driving circuit in accordance with an embodiment of the present document is reduced to about 10 dB (the peak P3 is about 88 dB, and the valley P4 is about 100 dB), thus the corresponding index for measuring the signal distortion is reduced drastically.

The above description is merely preferable embodiments of the present document, instead of limiting the protection scope of the present document. All the modifications, equivalent substitutions, and improvements, etc. made within the scope and principle of the present document shall fall into the protection scope of the present document.

### INDUSTRIAL APPLICABILITY

The piezoelectric speaker driving device in accordance with the present document simply improves the quality of the reproduced sound of the high-frequency part of the piezoelectric speaker without changing the structure and the assembly of the piezoelectric speaker, and the piezoelectric speaker driving device ameliorates the problems of an increased driving power consumption and a self-oscillation of the circuit caused by the low impedance of the high-frequency part of the piezoelectric ceramic element.

What is claimed is:

1. A piezoelectric speaker driving device comprising a driving amplification unit for amplifying a signal source, and a piezoelectric speaker, characterized in that the piezoelectric speaker driving device further comprises a signal tuning unit, wherein
the signal tuning unit is configured to filter a signal amplified by the driving amplification unit to filter out a high-frequency noise, regulate an impedance characteristic of a piezoelectric ceramic of the piezoelectric speaker, and transmit a regulated driving signal to the piezoelectric speaker to drive the piezoelectric speaker.

2. The piezoelectric speaker driving device of claim 1, wherein, the signal tuning unit comprises a low-pass filtering circuit and a regulation impedance.

3. The piezoelectric speaker driving device of claim 2, wherein, the driving amplification unit comprises a power amplifier and a power supply configured to supply the power to the power amplifier;
the low-pass filtering circuit is configured to be composed of an inductor cascaded in an output loop of the power amplifier and a capacitor connected in parallel in the output loop of the power amplifier, to filter out the high-frequency noise of an amplified signal from the power amplifier; and attenuate a high-frequency part of a sound pressure frequency responding curve of the piezoelectric speaker at a same time;
the regulation impedance is configured to be a resistor cascaded in the output loop of the power amplifier to regulate the impedance characteristic of the piezoelectric ceramic of the piezoelectric speaker.

4. The piezoelectric speaker driving device of claim 3, wherein, an inductance of the inductor, a capacitance of the capacitor, and a resistance of the resistor are determined based on frequencies corresponding to resonance peaks and resonance valleys of the high-frequency part of the piezoelectric speaker.

5. The piezoelectric speaker driving device of claim 3, wherein,
the inductor is a chip magnetic low-frequency inductor having an inductance in a range of 10 uH˜10 mH;
the capacitor is a chip ceramic capacitor having a capacitance in a range of 1 nF˜1 uF;
the resistor is a chip metal film resistor having a resistance in a range of 10˜100 ohm.

6. The piezoelectric speaker driving device of claim 3, wherein, the inductance is 130 uH; the capacitance is 0.47 uF; and the resistance is 22 ohm.
